(19) United States
(12) Patent Application Publication
(10) Pub. No.: US 2015/0225024 A1
(43) Pub. Date: Aug. 13, 2015

(54) FOLDAWAY TRUCK BED EXTENDER

(71) Applicant: Zack Newberry, Las Vegas, NV (US)

(72) Inventor: Zack Newberry, Las Vegas, NV (US)

(21) Appl. No.: 14/178,263

(22) Filed: Feb. 11, 2014

(51) Int. Cl. B62D 33/027; B60P 3/40

(52) U.S. Cl. CPC B62D 33/0273; B60P 3/40

(57) ABSTRACT

A foldaway truck bed extender provides a truck bed extension that is unobtrusive regardless of whether the extender is deployed or folded away so that the extender can be permanently affixed to a vehicle without changing the vehicles cargo hauling capacity or functionality. The extender comprises a planar body having rotatable sidewall extensions all configured to fit within a thin low profile area. The extender rotates folds to and deploys from a tailgate of a truck or other vehicle.

### BACKGROUND OF THE INVENTION

1. Field of the Invention

The invention relates generally to truck bed extenders and in particular to a foldaway truck bed extender that elongates truck beds when in use and folds away to be nonintrusive when not in use.

2. Related Art

The development of pickup trucks has followed a path whereby truck beds have been reduced in length over time. When hauling longer objects, truck owners often lower the tailgate of their trucks, which elongates the truck bed by providing an additional horizontal surface at the back end of the truck bed (formed by the tailgate itself). The object may be tied down so as to prevent it from sliding or falling out of the back end of the truck bed while the tailgate is lowered.

Alternatively or in addition, a separate barrier may be installed to enclose the truck bed while the tailgate is lowered. The barrier generally extends between the sidewalls of the truck bed at the tailgate. In this manner, objects are secured in the truck bed, while the tailgate is lowered, because the barrier physically blocks objects from sliding or falling out of the truck bed.

From the discussion that follows, it will become apparent that the present invention addresses the deficiencies associated with the prior art while providing numerous additional advantages and benefits not contemplated or possible with prior art constructions.

### SUMMARY OF THE INVENTION

A foldaway truck bed extender and methods for extending a truck bed using the same are disclosed herein. The foldaway truck bed extender is highly advantageous in that it provides truck bed extension on demand. As discussed further herein, the foldaway truck bed extender has a thin planar design that allows a user to permanently install the foldaway truck bed extender on his or her truck. In this manner, the foldaway truck bed extender is available whenever it is needed and can fold away without limiting the cargo capacity or functionality of the user's truck bed or tailgate.

Various embodiments of the foldaway truck bed extender are disclosed herein. For example, the foldaway truck bed extender may be provided as part of an extender assembly for a truck bed. Such extender assembly may comprise a foldaway truck bed extender and a tailgate.

The foldaway truck bed extender itself will typically comprise a planar body having a recess, a first hinge at a first side of the planar body, and a second hinge at a second side of the planar body. In addition, a first sidewall extension rotatably attached to the planar body by the first hinge and configured to fit within the recess and a second sidewall extension rotatably attached to the planar body by the second hinge and configured to fit within the recess along with the first sidewall extension will typically be included.

The first hinge and the second hinge are typically oriented to allow the first sidewall extension and the second sidewall extension to rotate outward from a retracted position where the first sidewall extension and the second sidewall extension are within the recess to an extended position where the first sidewall extension and the second sidewall extension are substantially perpendicular to the planar body.

The tailgate will typically comprise a pivoting mechanism at its proximal end, wherein the pivoting mechanism configured to allow the tailgate to rotate between a raised position and a lowered position.

Also, a rotatable mounting assembly is typically included to rotatably attach a proximal end of the planar body of the foldable truck bed extender to a distal end of the tailgate such that the foldable truck bed extender is rotatable between a folded position where the foldable truck bed extender is adjacent to the tailgate to a deployed position where the foldable truck bed extender extends outward from the tailgate. The planar body is oriented such that the recess in the planar body opens towards the tailgate when in the folded position. This conceals the first and second sidewall extensions when the foldaway truck bed extender is in the folded position.

It is noted that the first hinge and the second hinge may include a biasing spring configured to bias the first sidewall extension and the second sidewall extension outward from the planar body. In addition, the first sidewall extension and the second sidewall extension may be thinner than the planar body's recess to fit completely therein when in the retracted position. Also, the planar body may comprise an elongated rectangular frame having a peripheral size and shape substantially the same as that of the tailgate.

A second recess may be located in the tailgate and configured to accept at least a portion of the foldaway truck bed extender's body therein. When attached to the truck bed, the tailgate and foldable truck bed extender rotate vertically. When the foldable truck bed extender is rotated to be perpendicular to the tailgate, the first sidewall extension and the second sidewall extension rotate horizontally.

In another exemplary embodiment, the foldaway truck bed extender for attachment to a tailgate may comprise a planar body having a rectangular frame dimensioned to match a length and height of the tailgate, and a back panel attached to the rectangular frame and configured to enclose a back side of the rectangular frame.

In this exemplary embodiment, the foldaway truck bed extender also comprises a first hinge at a first side of the planar body, a second hinge at a second side of the planar body, and first and second sidewall extensions. The first sidewall extension is rotatably attached to the planar body by the first hinge and configured to fit within the recess, and the second sidewall extension is rotatably attached to the planar body by the second hinge and configured to fit within the recess along with the first sidewall extension.

The first hinge and the second hinge will typically be oriented to allow the first sidewall extension and the second sidewall extension to rotate outward from a retracted position where the first sidewall extension and the second sidewall extension are adjacent the planar body to an extended position where the first sidewall extension and the second sidewall extension are substantially perpendicular to the planar body.

In addition, a rotatable mounting assembly is at a proximal end of the planar body and configured to rotatably attach the planar body to a distal end of the tailgate such that the foldable truck bed extender is rotatable between a folded position where the foldable truck bed extender is adjacent to the tailgate to a deployed position where the foldable truck bed extender extends outward from the tailgate. The first sidewall extension and the second sidewall extension will typically be positioned at the lateral ends of the tailgate when in the deployed position.

It is contemplated that the first sidewall extension and the second sidewall extension may be sized to match the height of the tailgate. Also, the first hinge and the second hinge may include a biasing spring configured to bias the first sidewall extension and the second sidewall extension outward from the planar body. In addition, the first sidewall extension and the second sidewall extension may be thinner than the planar body to fit completely within the planar body's frame when in the retracted position. The planar body may itself be dimensioned such that it is thinner than the tailgate as well. In operation, the planar body of the foldable truck bed extender rotates vertically when installed.

As stated, various methods for extending a truck bed with a foldaway truck bed extender are disclosed herein. For example, a method for extending a truck bed with a foldaway truck bed extender may comprise rotatably attaching a proximal end of a planar body of the foldaway truck bed extender to a distal end of a tailgate of the truck bed using a rotatable mounting assembly where the proximal end extends between and perpendicular to a first lateral end and a second lateral end of the planar body, rotatably attaching a first sidewall extension to the first lateral end of the planar body using a first hinge, and rotatably attaching a second sidewall extension to the second lateral end of the planar body using a second hinge, the second lateral end opposite the first lateral end.

The first sidewall extension and second sidewall extension typically rotate between a retracted position where the first sidewall extension and second sidewall extension are positioned adjacent the planar body and an extended position where the first sidewall extension and second sidewall extension extend outward perpendicular to the planar body, while the planar body rotates between a folded position where the planar body is adjacent the tailgate and a deployed position where the planar body is perpendicular to the tailgate.

Deployment of the foldaway truck bed extender may be accomplished by rotating the planar body outward from the folded position to the deployed position, and rotating the first sidewall extension and second sidewall extension outward from the retracted position to the extended position. The foldaway truck bed extender may be folded away by rotating the first sidewall extension and second sidewall extension inward from the extended position to the retracted position, and rotating the planar body inward from the deployed position to the folded position.

It is noted that a distal end of the first sidewall extension and the second sidewall extension may be attached to a back end of each sidewall of the truck bed using one or more fasteners. In this manner, the fasteners hold the first sidewall extension and second sidewall extension in the extended position. The tailgate may be rotatably attached to the back end of the truck bed. Also, a recess may be formed in the tailgate to receive the planar body of the foldaway truck bed extender.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A is a perspective view of an exemplary extender assembly and foldaway truck bed extender in a folded configuration;

FIG. 1B is a perspective view of an exemplary extender assembly and foldaway truck bed extender in a deployed configuration;

FIG. 2A is a perspective view of an exemplary extender assembly and foldaway truck bed extender in a folded configuration;

FIG. 2B is a perspective view of an exemplary extender assembly and foldaway truck bed extender in a lowered position;

FIG. 2C is a perspective view of an exemplary extender assembly and foldaway truck bed extender in a partially deployed configuration;

FIG. 2D is a perspective view of an exemplary extender assembly and foldaway truck bed extender in a deployed configuration;

FIG. 3A is a top view of an exemplary foldaway truck bed extender in a folded configuration;

FIG. 3B is a top view of an exemplary foldaway truck bed extender in a deployed configuration; and

FIG. 3C is a front view of an exemplary foldaway truck bed extender in a folded configuration.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The foldaway truck bed extender herein provides a number of benefits. In addition to extending a truck bed, the foldaway truck bed extender is compact and unobtrusive and therefore does not unnecessarily occupy space in a truck bed regardless of whether the foldaway truck bed extender is or is not in use. In addition, the foldaway truck bed extender does not obstruct vehicle brake, tail or turn signal indicators regardless of whether it is or is not in use. This efficient space utilization allows the foldaway truck bed extender to be permanently installed, if desired. In fact, it is contemplated that the foldaway truck bed extender may be integrated or built into a truck's tailgate in one or more embodiments.

A user therefore need not worry if he or she has the foldaway truck bed extender since the foldaway truck bed extender will always be available for use. Also, when not in use the foldaway truck bed extender “folds away” so as to not intrude upon the storage space of a truck bed or alter the appearance of the truck.

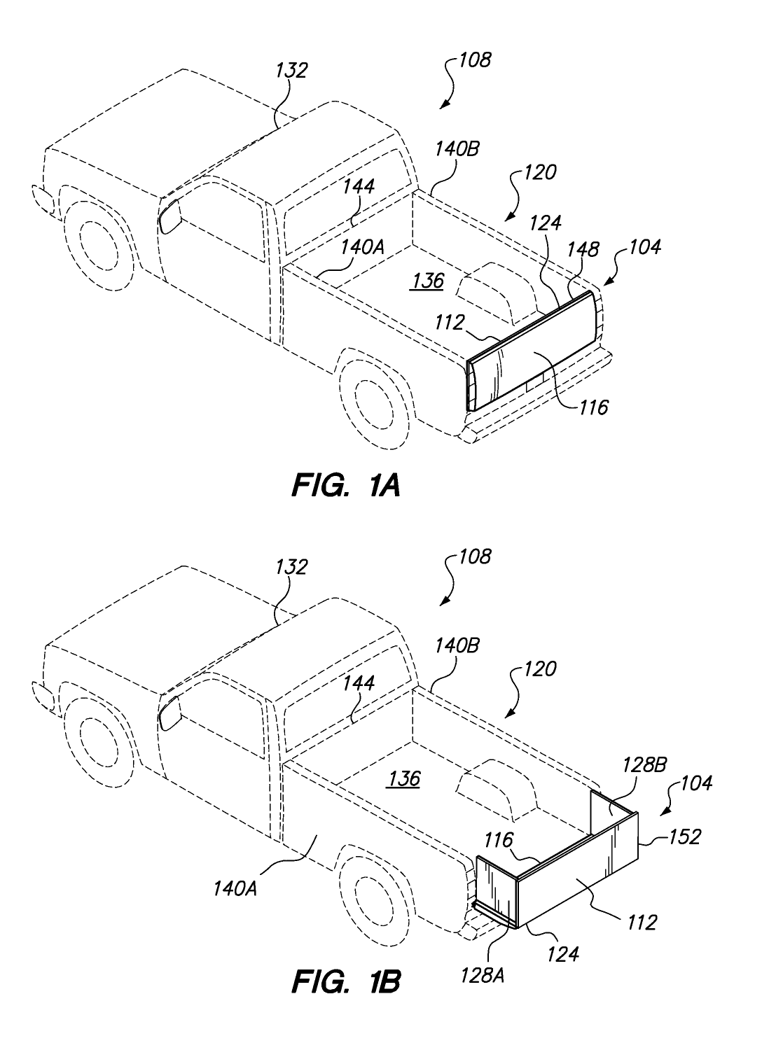

FIGS. 1A-1B illustrate an exemplary truck 108 that has the foldaway truck bed extender 112. As will be described further below, the foldaway truck bed extender 112 may be part of an extender assembly 104 that comprises a tailgate 116 and the foldaway truck bed extender 112. When in a folded configuration, the extender assembly 104 is configured to provide a proximal rear wall 148, such as shown in FIG. 1A. When deployed (to extend a truck bed), the extender assembly provides a distal rear wall 152 while extending a truck's bed 120, such as shown in FIG. 1B.

As can be seen, the truck 108 has a cab 132 or passenger compartment at its front end, and a bed 120 or cargo compartment forming its back end. It is noted that the cab 132 and bed 120 may be supported by a frame that also supports the drive train, engine, suspension, wheels and other components of the truck 108.

The bed 120 is configured to accept cargo or one or more other objects to be hauled by the truck 108. As shown in FIGS. 1A-1B for example the bed 120 comprises a bottom 136, two sidewalls 140A, 140B and a front wall 144. Any objects placed into the bed 120 are thus held therein by the sidewalls 140A, 140B and front wall 144, while being supported by the bed's bottom 136.

A tailgate 116 is located the back end of the bed 120, and will typically be rotatable or movable between a raised position and a lowered position. In the raised position, the tailgate 116 forms a proximal rear wall 148 of the bed 120 between the sidewalls 140A, 140B of the bed. Any objects placed into the bed 120 are thus prevented from escaping at the back end of the bed 120 by the tailgate 116. In the lowered position, the tailgate 116 extends outward from the back end of the bed 120, and no longer forms or provides the proximal rear wall 148.

Typically the tailgate 116 will be coplanar with the bottom 136 of the bed 120 when in its lowered position, such as shown in Figure lB. This serves to extend the length of the bed's bottom 136. The foldaway truck bed extender 112, when deployed, then extends the length of the sidewalls 140A, 140B and forms a distal rear wall 152 at an extended distance from the front wall 144, as will now be described with reference to FIGS. 1A-1B.

In FIG. 1A, the extender assembly 104 and foldaway truck bed extender 112 are in a folded configuration. As can be seen the foldaway truck bed extender 112 is positioned adjacent and parallel to the truck's tailgate 116. In the folded configuration, the foldaway truck bed extender 112 occupies very little space in the bed 120. This is because the foldaway truck bed extender 112 has a thin planar shape that adds very little to the width to the extender assembly 104.

It is contemplated that a tailgate 116 may be made thinner so that the overall extender assembly 104, when folded, has the same or similar width as a traditional tailgate. In addition or alternatively, it is contemplated that a tailgate 116 may have a recess configured to accept the foldaway truck bed extender 112. In this manner, the foldaway truck bed extender 112 is coplanar with the tailgate 116 when in a folded configuration and therefore the extender assembly 104 occupies no more space than the tailgate 116 itself.

In FIG. 1B, the extender assembly 104 and foldaway truck bed extender 112 are in a deployed or extended configuration. As can be seen, the tailgate 116 of the extender assembly 104 has been placed in its lowered position. This allows the foldaway truck bed extender 112 to be unfolded (i.e., deployed/extended) from the lowered tailgate 116 to provide a distal rear wall 152, and to extend the sidewalls 140A, 140B of the bed 120 with a pair of side wall extensions 128A, 128B. This provides a significant expansion of the bed 120 allowing larger, longer or more cargo to be placed securely within the bed.

When extension/enlargement of the bed 120 is no longer desired, the foldaway truck bed extender 112 and extender assembly 104 can be folded back to its planar folded configuration where it occupies little or no additional space in the truck bed 120 or elsewhere, such as shown and described with regard to FIG. 1A. This is in contrast to traditional truck bed extenders, which occupy a significant amount of storage space in a truck bed when not deployed. Traditional truck bed extenders may be removed completely from a truck to alleviate this issue; however, this is inconvenient and reduces the utility of the extender since it will inevitably not be installed on the truck just when it is needed. In addition, when removed from a truck, a user must then find and/or allocate significant storage space elsewhere to store a traditional truck bed extender.

In contrast, the extender assembly 104 and foldaway truck bed extender 112 can be used in a wide variety of usage scenarios while, in no case, reducing the functionality of a truck 108 or its bed 120 as provided by an OEM. For instance, as described above, the foldaway truck bed extender 112 occupies little or no space in the bed 120 of a truck 108 when not deployed. In addition, there is no limitation on the movement or functionality of a truck's tailgate 116 caused by the installation of the foldaway truck bed extender 112. For example, a user may raise and lower the tailgate 116 without deploying the foldaway truck bed extender 112.

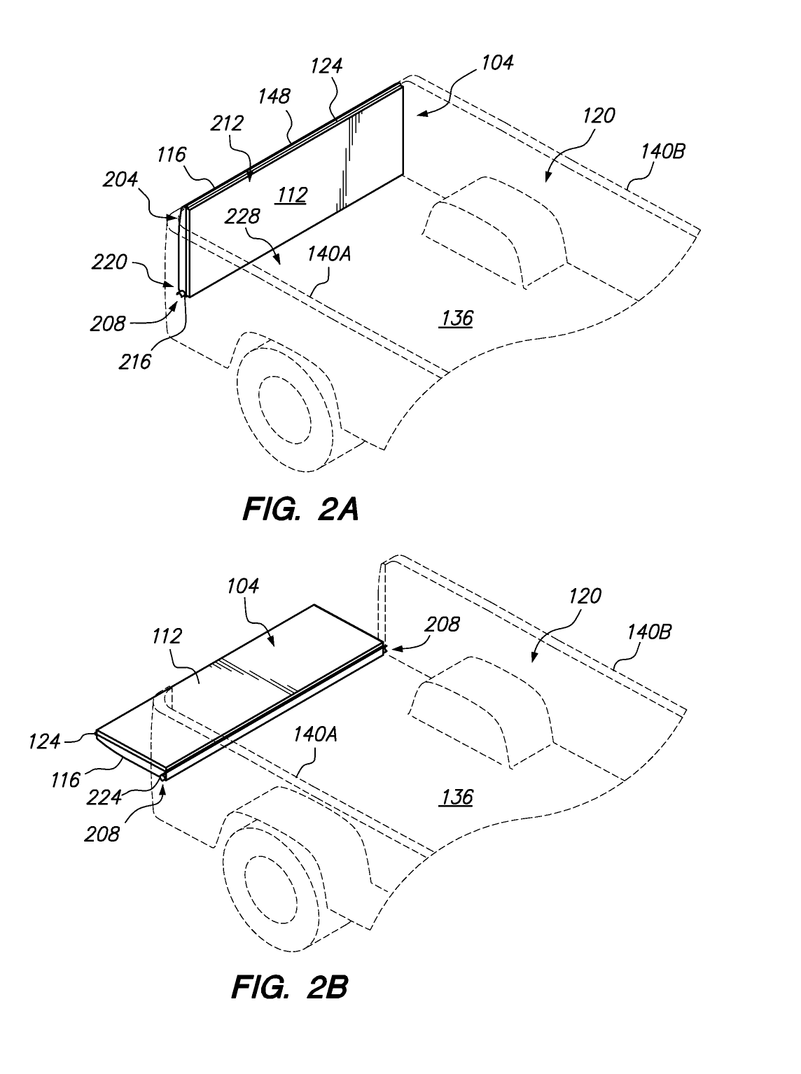

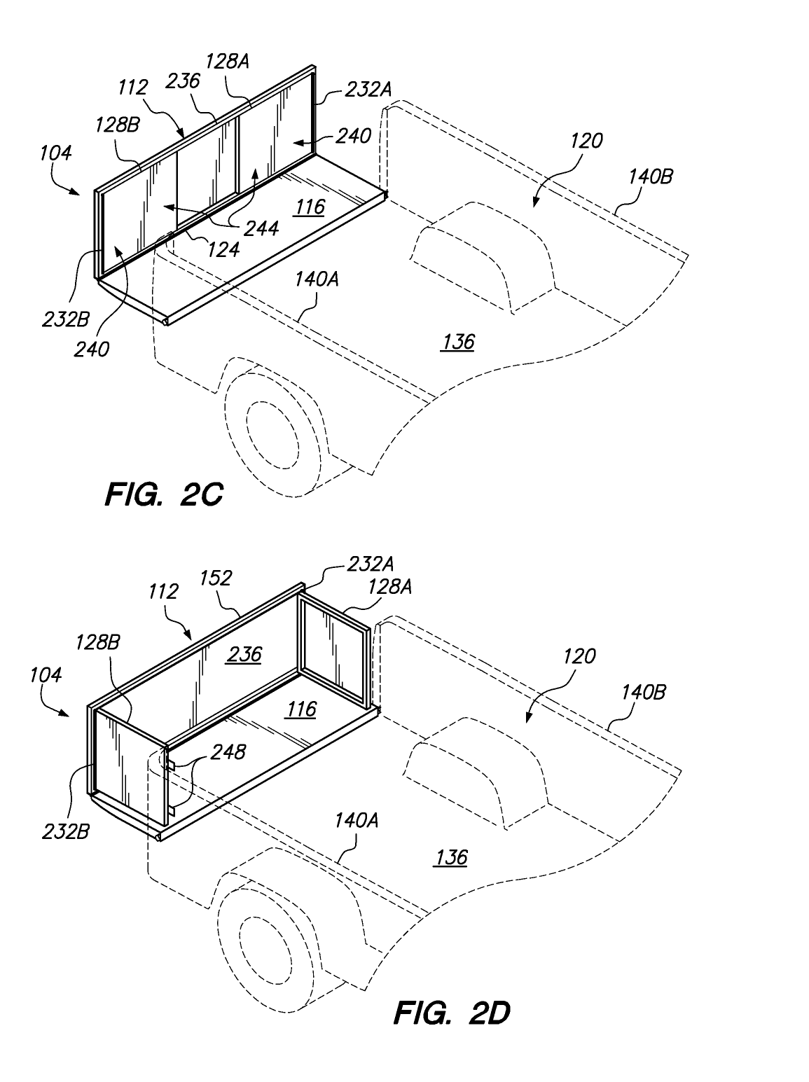

Further details regarding the operation of the extender assembly 104 and foldaway truck bed extender 112 will now be described with regard to the partial cross-sectional perspective views of FIGS. 2A-2D. As can be seen, FIGS. 2A-2D show the extender assembly 104 and foldaway truck bed extender 112 progressing from a folded configuration to a deployed or extended configuration. It is noted that these steps may be reversed to return the extender assembly 104 and foldaway truck bed extender 112 from the deployed configuration to the folded configuration.

FIG. 2A provides a perspective view of the extender assembly 104 and foldaway truck bed extender 112 in a folded configuration. The extender assembly 104 is also shown in a raised position to form a proximal back wall 148 that encloses the back end of the bed 120. The foldaway truck bed extender 112 is adjacent and parallel to the tailgate 116 in this configuration. As can be seen, the foldaway truck bed extender 112 may be rotatably attached to the tailgate 116 by one or more hinges 124 (such as piano hinges or the like), pivots or the like. Typically a hinge 124 will attach the foldaway truck bed extender 112 to the distal end 204 of the tailgate 116, such as shown. This connects a proximal end 212 of the foldaway truck bed extender 112 to the distal end 204 of the tailgate 116 and allows the foldaway truck bed extender to rotate relative to the tailgate 116.

The tailgate 116 itself will typically be rotatably attached to the truck bed 120 by a rotatable mounting assembly 208. The rotatable mounting assembly may comprise a socket 216 and corresponding socket pin 224, rod or axel. To illustrate, as shown the tailgate 116 has a socket 216 at its proximal end 220 configured to accept the pin 224 extending from the bed 120. In operation, the tailgate 116 is rotatable between its lowered and raised position about this axel. It is noted that the rotatable mounting assembly 208 may be formed by other rotating mechanisms. For example, the rotatable mounting assembly 208 may comprise one or more hinges, pivots or the like that rotatably attach the proximal end 220 of the tailgate 116 to the distal end 228 of the bed 120.

FIG. 2B illustrates shows the extender assembly 104 having been rotated from the raised position of FIG. 2A to a lowered position. As can be seen, the tailgate 116 is now coplanar with the bottom 136 of the bed 120. The tailgate 116 extends the bottom 136 of the bed 120 in this manner. It is noted that, since the foldaway truck bed extender 112 has a compact planar shape that is parallel with the tailgate 116, the extender assembly 104 may be used while in this lowered position without any further action. For example, as can be seen from FIG. 2B, an object may be placed in the bed 120 and extend onto or beyond the foldaway truck bed extender 112 while the extender assembly 104 is at its lowered position. Such object would likely need to be tied down or otherwise secured to the bed 120 so as to prevent it from falling or sliding out of the back end of the bed however.

FIG. 2C illustrates partial deployment of the foldaway truck bed extender 112 of the extender assembly 104. As can be seen, the foldaway truck bed extender 112 may be rotated from its lowered position, shown in FIG. 2B, to the raised position shown in FIG. 2C. It can be seen that the foldaway truck bed extender 112 forms a distal back wall 152 for the bed 120 when raised.

As can also be seen from FIG. 2C, raising the foldaway truck bed extender 112 exposes its sidewall extensions 128A, 128B so that they may be deployed or extended as well. In one or more embodiments, the sidewall extensions 128A, 128B are rotatably mounted to each side of the foldaway truck bed extender's body 236 at their proximal ends 240. As shown for example, the sidewall extensions 128A, 128B are rotatably mounted to the body 236 by one or more hinges 232A, 232B such that the sidewall extensions 128A, 128B may swing outward in a lateral direction. It is noted that various other rotating or pivoting mechanisms may be used to rotatably attach the sidewall extensions 128A, 128B.

The sidewall extensions 128A, 128B are rotatably attached such that they can swing outward laterally from their retracted position, shown in FIG. 2C, to an extended position, such as that shown in FIG. 2D. As can be seen from FIG. 2D for instance, the sidewall extensions 128A, 128B have both been rotated laterally about their respective hinges 232A, 232B to the sides of the tailgate 116. In this manner, the distal ends 244 of the sidewall extensions 128A, 128B become positioned adjacent the ends of the sidewalls 140A, 140B of the bed 120, thereby extending the sidewalls of the bed.

In one or more embodiments, a locking mechanism may be used to hold the sidewall extensions 128A, 128B in an extended position. For example, spring or other biased hinges 232A, 232B may be used to hold the sidewall extensions 128A, 128B in an extended position once they are extended from the body 236 of the foldaway truck bed extender 112. Alternatively or in addition, one or more folding struts may be extended between a sidewall extension 128 and the body 236 to hold the sidewall extension in an extended position. In yet another example, one or more fasteners 248 (such as one or more magnets, latches, pins and corresponding openings) at the distal end 244 of the sidewall extensions 128A, 128B may engage corresponding fasteners at the back end of the sidewalls 140A, 140B to hold the sidewall extensions at an extended position.

It can be seen from FIG. 2D that when the extender assembly 104 and foldaway truck bed extender 112 are fully deployed, the bed 120 is extended and expanded by a significant amount while also being enclosed (by the foldaway truck bed extender's body 236 and sidewall extensions 128A, 128B) to ensure cargo does not fall out of the bed 120.

When the above-described process is performed in reverse, the extender assembly 104 and foldaway truck bed extender 112 are returned to a folded configuration that is compact and unobtrusive, as previously described. To illustrate, the sidewall extensions 128A, 128B can be rotated from their extended position, shown in FIG. 2D, to a retracted position, such as that shown in FIG. 2C. Thereafter, the body 236 of the foldaway truck bed extender 112 can be rotated from the raised position shown in FIG. 2C to its lowered position shown in FIG. 2B. The entire extender assembly 104 can then be raised, such as by rotating the tailgate 116 to a raised position, to arrive at the raised position shown in FIG. 2A. As can be seen, even though the foldaway truck bed extender 112 remains installed and attached to the tailgate 116 (i.e., available for use at any moment), it is completely unobtrusive and preserves the cargo capacity and functionality of the truck bed 120 when in a folded configuration. In fact, the foldaway truck bed extender 112 is not even readily visible.

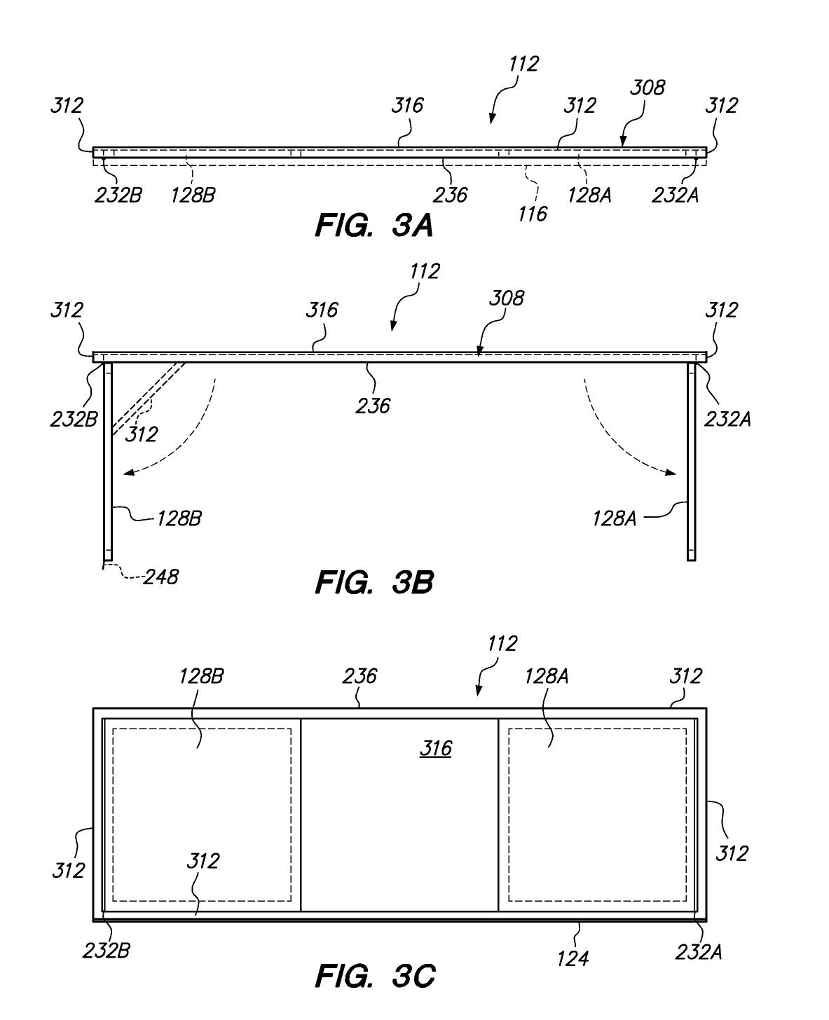

Components and construction of an exemplary foldaway truck bed extender 112 will now be described with regard to FIGS. 3A-3C. Referring to the top view of Figure 3A (showing the foldaway truck bed extender 112 in a folded configuration), it can be seen that the foldaway truck bed extender's body 236 has a thin planar shape with a recess 308 or cavity therein configured to accept and store the sidewall extensions 128A, 128B. To illustrate, FIG. 3A illustrates the sidewall extensions 128A, 128B retracted in the recess 304 of the body 236. The recess 308 may be configured to accept the entirety of the sidewall extensions 128A, 128B such that they do not protrude outward from the recess. This reduces the thickness of the foldaway truck bed extender 112. As noted above, the foldaway truck bed extender 112 itself may optionally be installed within a recess 308 or cavity in a tailgate 116 to greatly reduce or eliminate the amount of truck bed space occupied by the foldaway truck bed extender. Such an embodiment is shown in FIG. 3A.

The sidewall extensions 128A, 128B are rotatably attached to the body 236 via hinges 232A, 232B, which allow the sidewall extensions to rotate outward laterally to their extended position as shown in the top view of FIG. 3B. A strut 312 and fastener 248, as described above with regard to FIG. 2D, is shown in FIG. 3B to hold the sidewall extensions 128A, 128B in an extended position. It is noted that a strut 312 and/or fastener 248 are optional and need not be included in all embodiments.

FIG. 3C provides a front view of the foldaway truck bed extender 112 in a folded configuration. Similar to FIG. 3A, FIG. 3C shows the sidewall extensions 128A, 128B in a retracted position. As can be seen, the body 236 of the foldaway truck bed extender 112 may comprise an outer frame 312 that forms the outer periphery of the body. It is contemplated that the frame 312 may comprise individual tubes or other members connected together to form a planar frame. A back panel 316 may be attached to one side of the frame 312 to enclose the back of the frame. It is noted that the back panel 316 provides a barrier that forms the distal back wall to prevent items from falling out of the bed when extended by the foldaway truck bed extender 112. In addition, the back panel 316 may serve as a supporting surface when the extender assembly 104 is in a lowered position and the foldaway truck bed extender 112 has not been deployed/extended, such as shown in FIG. 2B.

Typically, the extender assembly 104 and foldaway truck bed extender 112 will be constructed from one or more rigid materials, such as one or more metals or alloys thereof. Other non-metal materials may be used as well, such as carbon fiber, plastics or other synthetic materials. In some embodiments, various portions of the foldaway truck bed extender 112 may be constructed from different materials. For example, the frame 312 may be constructed from a first material, such as a metal, while the back panel 316 (or other portion(s)) are constructed from a second material, such as plastic. The materials may be selected based on desired characteristics, such as to improve rigidity, prevent rust, reduce weight, lower cost, or the like.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An extender assembly for a truck bed comprising:
a foldaway truck bed extender comprising:
a planar body having a recess;
a first hinge at a first side of the planar body;
a second hinge at a second side of the planar body;
a first sidewall extension rotatably attached to the planar body by the first hinge and configured to fit within the recess; and
a second sidewall extension rotatably attached to the planar body by the second hinge and configured to fit within the recess along with the first sidewall extension;
wherein the first hinge and the second hinge are oriented to allow the first sidewall extension and the second sidewall extension to rotate outward from a retracted position where the first sidewall extension and the second sidewall extension are within the recess to an extended position where the first sidewall extension and the second sidewall extension are substantially perpendicular to the planar body;
a tailgate comprising a pivoting mechanism at its proximal end, the pivoting mechanism configured to allow the tailgate to rotate between a raised position and a lowered position; and
a rotatable mounting assembly rotatably attaching a proximal end of the planar body of the foldable truck bed extender to a distal end of the tailgate such that the foldable truck bed extender is rotatable between a folded position where the foldable truck bed extender is adjacent to the tailgate to a deployed position where the foldable truck bed extender extends outward from the tailgate;
wherein the planar body is oriented such that the recess in the planar body opens towards the tailgate when in the folded position.

2. The extender assembly of claim 1, wherein the first hinge and the second hinge include a biasing spring configured to bias the first sidewall extension and the second sidewall extension outward from the planar body.

3. The extender assembly of claim 1, wherein the first sidewall extension and the second sidewall extension are thinner than the planar body's recess to fit completely therein when in the retracted position.

4. The extender assembly of claim 1, wherein the planar body comprises an elongated rectangular frame having a peripheral size and shape substantially the same as that of the tailgate.

5. The extender assembly of claim 1 further comprising a second recess located in the tailgate, the second recess configured to accept at least a portion of the foldaway truck bed extender's body therein.

6. The extender assembly of claim 1, wherein, when attached to the truck bed, the tailgate and foldable truck bed extender rotate vertically.

7. The extender assembly of claim 6, wherein, when the foldable truck bed extender is rotated to be perpendicular to the tailgate, the first sidewall extension and the second sidewall extension rotate horizontally.

8. A foldaway truck bed extender for attachment to a tailgate comprising:
a planar body comprising:
a rectangular frame dimensioned to match a length and height of the tailgate; and
a back panel attached to the rectangular frame and configured to enclose a back side of the rectangular frame;
a first hinge at a first side of the planar body;
a second hinge at a second side of the planar body;
a first sidewall extension rotatably attached to the planar body by the first hinge and configured to fit within the recess;
a second sidewall extension rotatably attached to the planar body by the second hinge and configured to fit within the recess along with the first sidewall extension;
wherein the first hinge and the second hinge are oriented to allow the first sidewall extension and the second sidewall extension to rotate outward from a retracted position where the first sidewall extension and the second sidewall extension are adjacent the planar body to an extended position where the first sidewall extension and the second sidewall extension are substantially perpendicular to the planar body; and
a rotatable mounting assembly at a proximal end of the planar body and configured to rotatably attach the planar body to a distal end of the tailgate such that the foldable truck bed extender is rotatable between a folded position where the foldable truck bed extender is adjacent to the tailgate to a deployed position where the foldable truck bed extender extends outward from the tailgate;

9. The foldaway truck bed extender of claim 8, wherein the first sidewall extension and the second sidewall extension are sized to match the height of the tailgate.

10. The foldaway truck bed extender of claim 8, wherein the first hinge and the second hinge include a biasing spring configured to bias the first sidewall extension and the second sidewall extension outward from the planar body.

11. The foldaway truck bed extender of claim 8, wherein the first sidewall extension and the second sidewall extension are thinner than the planar body to fit completely within the planar body's frame when in the refracted position.

12. The foldaway truck bed extender of claim 8, wherein the planar body is dimensioned such that it is thinner than the tailgate.

13. The foldaway truck bed extender of claim 8, wherein the planar body of the foldable truck bed extender rotates vertically when installed.

14. The foldaway truck bed extender of claim 8, wherein, the first sidewall extension and the second sidewall extension are positioned at the lateral ends of the tailgate when in the deployed position.

15. A method for extending a truck bed with a foldaway truck bed extender comprising:
rotatably attaching a proximal end of a planar body of the foldaway truck bed extender to a distal end of a tailgate of the truck bed using a rotatable mounting assembly, wherein the proximal end extends between and perpendicular to a first lateral end and a second lateral end of the planar body;
rotatably attaching a first sidewall extension to the first lateral end of the planar body using a first hinge; and
rotatably attaching a second sidewall extension to the second lateral end of the planar body using a second hinge, the second lateral end opposite the first lateral end;
wherein the first sidewall extension and second sidewall extension rotate between a refracted position where the first sidewall extension and second sidewall extension are positioned adjacent the planar body and an extended position where the first sidewall extension and second sidewall extension extend outward perpendicular to the planar body;
wherein the planar body rotates between a folded position where the planar body is adjacent the tailgate and a deployed position where the planar body is perpendicular to the tailgate.

16. The method of claim 15 further comprising deploying the foldaway truck bed extender by:
rotating the planar body outward from the folded position to the deployed position; and
rotating the first sidewall extension and second sidewall extension outward from the retracted position to the extended position.

17. The method of claim 15 further comprising folding the foldaway truck bed extender by:
rotating the first sidewall extension and second sidewall extension inward from the extended position to the retracted position; and
rotating the planar body inward from the deployed position to the folded position.

18. The method of claim 15 further comprising attaching a distal end of the first sidewall extension and the second sidewall extension to a back end of each sidewall of the truck bed using one or more fasteners, wherein the fasteners hold the first sidewall extension and second sidewall extension in the extended position.

19. The method of claim 15 further comprising rotatably attaching the tailgate to the back end of the truck bed.

20. The method of claim 15 further comprising forming a recess in the tailgate to receive the planar body of the foldaway truck bed extender.
